(19) United States
(12) Patent Application Publication
(10) Pub. No.: US 2009/0119230 A1
(43) Pub. Date: May 7, 2009

(54) Commodities Based Securities and Roll Neutrality Therefor

(76) Inventors: Robert Allen Levin, Short Hills, NJ (US); Jay Lester Gottlieb, New York, NY (US)

Correspondence Address: KEITH D. NOWAK, CARTER LEDYARD & MILBURN LLP, 2 WALL STREET, NEW YORK, NY, 10005, US

(21) Appl. No.: 12/351,045

(22) Filed: Jan. 9, 2009

Related U.S. Application Data
(63) Continuation of application No. 11/243,015, filed on Oct. 3, 2005, now abandoned.

(51) Int. Cl. G06Q 40/00

(52) U.S. Cl. 705/36 R; 705/35

(57) ABSTRACT

The subject invention pertains to securities, preferably exchange traded funds, or ETFs, relating to commodities subject to futures contracts in a commodities market. More specifically, the invention relates to shipping certificates for commodities that dynamically compensate for commodity “roll neutrality” adjustments by altering the quantity of commodity associated with the shipping certificate, as opposed to a cash adjustment. The subject invention also pertains to the underlying “roll neutrality” adjustment related to a commodities market futures transaction and to the resulting ETF valuation as follows: Σ Pᵢ Bᵢ, where Pᵢ is the price of the relevant contract month, Bᵢ is the number of commodity units for that month, and ᵢ is the time index.

### RELATED HISTORY

This is a continuation of U.S. patent application Ser. No. 11/243,015 filed Oct. 3, 2005, in the name of Robert Allen Levin and Jay Lester Gottlieb, and entitled COMMODITIES BASED SECURITIES AND ROLL NEUTRALITY THEREFOR.

### BACKGROUND OF THE INVENTION

The present invention pertains to securities, and specifically, but not limited to, exchange traded funds in relation to commodities and to the underlying commodities markets. Many pooled investment vehicles invest substantially all of their assets in various types of securities, derivatives, commodities and other assets. Each such pooled investment vehicle is established using one of several legal structures, such as a “special purpose entity” or an “investment company” registered as such with the Securities and Exchange Commission under the Investment Company Act of 1940, as amended. Shares issued by these pooled investment vehicles may be purchased by individual and institutional investors and may be listed and traded on an exchange.

One particular type of pooled investment vehicle is the exchange traded fund, commonly referred to as an “ETF.” An ETF continuously issues and redeems its Shares “in-kind” in large lot-sizes (“Creation Units” herein) at daily net asset value (“NAV” herein) while listing its individual Shares on a securities exchange for secondary market trading at intraday prices. The listing exchange publicly disseminates ETF Share prices and information about the underlying portfolio assets (“Assets” herein) during the trading day.

Several different institutions are involved in establishing an ETF, as well as creating and redeeming its Shares in Creation Units and trading its Shares at prices that closely match the aggregate price of its Assets. So, for example, in addition to the listing exchange, there must be a firm or group of firms to organize and establish the ETF. Depending upon the ETF's legal structure, there will also be a manager or sponsor to monitor the ETF's Assets and to perform certain administrative duties. Also, each ETF will have a custodian that will hold its Assets in a special account, receive and pay dividends and the like. Financial firms called Authorized Participants (APs herein) are also necessary to create and redeem Creation Units. These firms must be capable of borrowing/purchasing/selling and clearing both the ETF's Shares and Assets “in kind” (e.g. stocks, other securities, forward contacts, gold bullion, and other commodities). In addition, exchange specialists or market makers are necessary to facilitate the trading of individual Shares in the secondary market at all times during the trading day. There also must be an entity designated to disseminate information about the composition of an ETF's Assets to facilitate creation and redemption activity, as well as an index provider if the ETF is based on or intends to track a specified index. Further, an ETF may appoint a firm to serve as distributor of its Shares and to perform marketing and advertising duties.

Once the ETF is established, Authorized Participants create Creation Units by purchasing or borrowing the specified kind and requisite amount of Assets for deposit with the ETF. The Authorized Participant will notify the ETF of its intent to purchase Creation Units and will deposit the Assets to be received and held by the custodian. In exchange, the ETF will issue its Shares in Creation Units to such Authorized Participants. The Authorized Participants may treat the Shares as they would any other security, (e.g.) they may hold the Creation Units for their own accounts as principal, fill existing agency orders for individual Shares sale to investors, place the Shares into inventory for future sales to investors and lend the Shares to short-sellers.

Redemption of Creation Units is simply the reverse of the creation mechanism described in the paragraph above. An Authorized Participant will notify the ETF of its intent to redeem Creation Units, will buy the requisite number of Shares to constitute one or more whole Creation Units and then will tender such Creation Units for redemption to the ETF. The ETF will receive and cancel the tendered Shares and will notify the custodian so that the corresponding amount of Assets will be presented “in kind” to the Authorized Participant. The Authorized Participant, as owner of the Assets, may treat them as it would any other like property.

This ETF creation, sale and redemption structure provides each entity involved with the opportunity for gain. The ETF's manager or sponsor generally takes as its fee a small portion of the fund's annual Assets, as clearly stated in the prospectus available to all investors. So too, the custodian will take as its fee a small portion of Assets, often paid for by the manager or sponsor out of its fees. The investors who lend Assets to Authorized Participants to assemble a Creation Unit take a small fee for this service, and those investors who sell Assets to the Authorized Participant usually sell them at a profit. The Authorized Participants are primarily driven by profits arising from the difference in price between the portfolio of Assets and the price of the Shares trading in the secondary market, as well as the gain imbedded in the bid-ask spread of the Shares. Whenever there is a discrepancy between the NAV of an ETF's Assets and the price of its Shares trading in the secondary market, an Authorized Participant will seize this arbitrage opportunity and execute the requisite purchase and sale transactions to realize the gain. Historically, this arbitrage mechanism has tended to keep prices of ETF Shares very close to the underlying NAV of the ETF's Assets.

The ETF structure allows for transparency and liquidity at modest cost. Everyone knows the nature and identity of the Assets held by an ETF, fees charged to investors are disclosed, fees earned by Authorized Participants are not paid by ETFs or their Shareholders, and individuals as well as institutions can access the secondary market to exit from their investment in Shares at any time during the trading day.

A commodity is an undifferentiated product whose market value arises from the owner's right to sell under a contract for future sale in a commodities market (i.e. under a futures contract), rather than the present right to use. Example commodities from the financial world include oil (sold by the barrel), electricity, wheat, and even pork-bellies. More modern commodities include bandwidth, RAM chips and (experimentally) computer processor cycles, and negative commodity units like emissions credits.

In the original and simplified sense, commodities were things of value, of uniform quality, that were produced in large quantities by many different producers; the items from each different producer considered equivalent. Now, however, it is the contract for future sale in a commodities market predicated on the underlying generic standardization that define the commodity.

The very nature of commodity futures contracts requires them to regularly expire. When this occurs an existing position needs to be continually “rolled” forward. This is rarely done at the same price. Storage, interest charges, short term supply/demand anomalies are just some of the factors that contribute to the difference in price between the near term futures contract price and a more distant futures contract price.

An example would be carrying a gold futures position. Gold is a market which trades almost exclusively in contango, which means that near term future contracts trade at a lower price than more deferred future contracts. (Backwardation is the term used when the opposite price structure is present). Presume one owns an August 2005 gold futures contract at a price of $426.00. This means the owner controls 100 ounces of gold at $426.00 per ounce. The August contract will “expire” on a particular day in August of 2005. In order to maintain this desired position of being “long” 100 ounces of gold, one can “roll” the futures position forward to a December 2005 contract. Thus, one must sell the August contract and buy a December contract. At the time this is done the December future is priced $9.00 above the August future. The position is the same as before but the price is now $9.00 higher. This $9.00 is not a profit but the “roll,” or carrying cost, of maintaining a gold position into the future.

Thus, the nature of commodity futures make it difficult to determine the actual long term returns associated with a passive position over long periods of time. A passive long term position needs to be continually rolled in order to avoid expiring contracts. The roll yield is the return associated with the continuous rolling of near term commodity contracts to more deferred ones. The levels of these rolls will either involve rolling into a lower priced contract (backwardation) or a more expensive one (contango). The roll yield may be either positive or negative, depending on the prices present during the roll period.

In contrast, and as discussed in further detail below, the “roll neutrality” adjustment associated with the subject invention relates not to the cost of the actual purchase of a more distant futures contract, but instead with neutralizing or ameliorating the effects of drastic monthly changes in the price of commodities on both the issuer and the bearer of a commodities-based exchange traded fund (ETF), tied to the “spot,” or current, price of the underlying commodities, that thus affects the value of this related ETF.

ETFs holding commodities as Assets have certain design features that are necessary to deal with the physical nature of commodities (e.g. shipping and storage requirements for frozen orange juice concentrate), as well as the related pricing and trading mechanics of futures markets for such commodities. These features are different from those of ETFs holding securities as Assets. So, for example, unlike securities which have a stated term (e.g. 30-year bond) or a perpetual term (e.g. common stock), commodity futures contracts are designed to expire on a regular basis. When this occurs, an existing futures position needs to be continually “rolled” forward, making it difficult to determine the actual long term returns associated with a passive position over long periods of time. The roll of a futures contract from one month's expiry to another rarely takes place at the same price, because storage, interest charges, short term supply/demand anomalies and other factors contribute to the difference in price between the near term futures contract price and a more distant futures contract price for such commodity. It is these above considerations affecting a commodities based ETF that the subject invention addresses and satisfies.

Further, an ETF holding a portfolio of securities can easily and cheaply receive, hold and transfer its Assets through the efficient trading, clearing, transfer and settlement systems utilized by broker dealers, banks and other financial intermediaries. Until recently, purchases, sales and transfers of securities were made via an exchange of paper certificates, but now such activities are often effected electronically. In contrast, most commodities until recently were physically delivered for immediate use or were held in storage until sold or used by others in the marketplace. Indeed, although futures contracts for some commodities are typically settled for cash, all futures contracts are capable of settlement though physical delivery of the commodity underlying such contracts. Over time, the commodities markets developed systems and procedures to provide commodities to their owners via transferable delivery documents; indeed some of these instruments are also transferable electronically. The term “delivery” in the commodities futures context generally refers to the change of ownership or control of a commodity under specific terms and procedures established by the exchange where which the futures contracts are traded. Usually, the commodity is required to be placed in an approved warehouse, grain silo, precious metals depository or other storage facility, and must be inspected by approved personnel, after which such approved facility issues a warehouse receipt, shipping certificate, demand certificate, or due bill, which becomes a transferable delivery instrument.

“Shipping Certificates” (referred to herein as “Shipping Certificates” or “Ship Certs”) are a type of delivery instrument which represents a commitment by the issuing approved storage facility to deliver the stated amount of the commodity to the owner of such Shipping Certificates according to the terms specified therein. Once Shipping Certificates are acquired and presented by the new owner to the issuing facility, such owner typically either can take possession of the physical commodity, deliver the delivery instrument into the futures market in satisfaction of a short position, or sell the delivery instrument to another market participant; such market participant in turn can use the Shipping Certificate for delivery into the futures market in satisfaction of his short position or for cash, or can take delivery of the physical commodity himself. In contrast to an issuer of warehouse receipts who holds the physical commodities in storage at the time it issues the delivery instrument, the issuer of a Shipping Certificate may honor its obligation to deliver the stated amount of commodities from current production or through-put as well as from inventories. The subject invention thus also addresses financial and logistical issues associated with a Shipping Certificate related to a commodities based ETF.

### SUMMARY OF THE INVENTION

The subject invention relates to ETFs pertaining to commodities subject to futures contracts in a commodities market. More specifically, the invention relates to Shipping Certificates that dynamically compensate for commodity “roll” adjustments by altering the quantity of commodity associated with each Shipping Certificate, as opposed to a cash adjustment.

Because of logistical considerations involved in the physical delivery of commodities, Crude Oil for example, it is necessary for the Issuers of Shipping Certificates to have prior notice of an Owner's intention to take delivery of such commodities. For example, in order to arrange for delivery of Crude Oil in the month of July, an Issuer of Crude Oil Shipping Certificates would require notice by a specific date in June from the Owner of such instruments. After that date, the Owner could no longer demand that delivery of Crude Oil be made in July, but could only demand delivery during the next month, in August.

The Shipping Certificates of the subject invention are based on a “roll neutrality” calculation based on both “spot month” oil (i.e. the month after the month in which notice by the Owner is given) and “second nearby” oil (i.e. the month after the spot month) over a three-day “roll period” as further described below. The roll period will begin on the ninth business day before the “Expiration Date” for the corresponding crude oil futures contract, on the New York Mercantile Exchange, Inc. (NYMEX, herein) for example, in each calendar month. The Expiration Date is the expiration date of the current spot futures contract for Crude Oil, currently the business day before the twenty-fifth calendar day of each month. As discussed below, it is expected that, absent the “roll neutrality” adjustment of the present invention, there would be significant economic gains or losses associated with this “roll” into the succeeding delivery month as described above. Failure to make such adjustment would render the Shipping Certificates as well as the commodities-based ETF of the subject invention less useful. Note, however, that to calculate the net asset value (NAV) all “second nearby” oil is used. Similarly, during the roll period, if the Shipping Certificate is surrendered all “second nearby” oil is to be received.

In trading, for example of Crude Oil futures contracts on the NYMEX and elsewhere, there is frequently a significant divergence between the trading price of the “spot” contract (which is the futures contract closest to Expiration Date) and more distant futures contracts. For example, in the first part of June, the July contract is the “spot” contract. If at that time the August contract is trading below the July spot contract, the condition is called “backwardation.” If the August contract is trading above the July spot contract, the condition is called “contango.” In either case, the “roll” under the Shipping Certificates can be expected to be advantageous to either the Issuer or the Owner and disadvantageous to the other, absent the “roll neutrality” (defined in the next paragraph below) adjustment of the present invention. Indeed, the “net asset value” of the ETF will be determined based upon the NYMEX trading price of that futures contract contemplating delivery in the same month(s) as the ETF's Shipping Certificates.

In order for the Shipping Certificates to be fair to both the Issuer and the Owner, and to ensure that the ETF Shares track changes in the spot price over the longer term, a mechanism has been invented as described herein that provides “roll neutrality,” whereby the price fluctuation in the commodities is mitigated to favor neither the Issuer nor the Owner. The subject invention accomplished this “roll neutrality” by providing for an adjustment to the number of barrels of Crude Oil deliverable under the Shipping Certificate, such adjustment to be calculated on the basis of the backwardation or contango in NYMEX trading over a three-day roll period.

The subject invention also pertains to the underlying “roll neutrality” adjustment related to a commodities market futures transaction and to the resulting ETF valuation as follows: Σ Pᵢ Bᵢ, where Pᵢ is the price of the relevant contract month, Bᵢ is the number of commodity units for that month, and ᵢ is the time index.

Preferably the commodity is oil and the commodities market is managed by the New York Mercantile Exchange.

Preferably, the “roll neutrality” adjustment is calculated on a three day basis such that, in relation to the associated ETF, one third of the quantity of commodity of the ETF is “rolled” from one month to the next on each of three successive days. Thus, this graduated roll over a three day period ameliorates drastic changes that occur in commodities markets in a single day and provides a smoothing of roll impact to both the investor and the issuer of the underlying asset.

Most preferably, combining the above graduated roll with the re-allocation of ETF value based on commodity amount instead of cash, in the case of oil, will result in an increase or decrease in the number of barrels held by the ETF.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1 is a flow chart of the exchange traded fund creation and redemption of the subject invention;

FIG. 2 is a partial data table of daily first month and second month commodity price data on a daily basis;

FIG. 3 is a partial data table of FIG. 2 further limited to predetermined “roll” dates;

FIG. 4 is a graphical representation showing commodity amounts gained or lost employing the roll adjustment method of the subject invention on a non-accumulated basis;

FIG. 5 is a partial data table showing commodity amounts gained or lost employing the roll adjustment method of the subject invention on an accumulated basis;

FIG. 6 is a graphical representation of FIG. 5 on a monthly basis;

FIG. 7 is a graphical representation of FIG. 6 on a yearly basis;

FIG. 8 is a partial data table showing roll data based on the roll adjustment method of the subject invention on both a monthly and yearly basis; and

FIG. 9 is a partial data table showing the frequency of backwardation versus contango based on the roll adjustment method of the subject invention.

### DETAILED DESCRIPTION OF THE PREFERRED EMBODIMENTS

The subject invention relates to securities, such as, but not limited to, exchange traded funds (ETFs) pertaining to commodities subject to futures contracts in a commodities market. By non-limiting example for the purposes of illustration only, and not to in any way be construed as limiting the scope of the subject invention, the futures contracts discussed herein are for Crude Oil, and the commodities market for Crude Oil is managed by the New York Mercantile Exchange, Inc. (NYMEX, herein). It will be readily apparent to one skilled in the art that the subject invention is readily applicable to other commodities and other commodities markets than described herein. The term “securities” as used herein is a transferable interest representing financial value, of which the ETF is a non-limiting example. “Securities” as used herein in association with the subject invention are dependent on a reference “commodity.” A “commodity” as used herein is an undifferentiated product whose market value arises from the owner's right to sell under a contract for future sale in a commodities market (i.e. under a futures contract), a non-limiting example of which is crude oil. “Roll neutrality” as used herein is, importantly, to be differentiated from the term “roll” that is historically used in the commodities industry. “Roll neutrality” as used herein does not relate to the cost of the actual purchase of a more distant futures contract (traditional “roll”), but instead is defined as a financial process to neutralize or ameliorate the effects of time based changes in the price of commodities on both the issuer and the bearer of a commodities-based security, such as an ETF, tied to the “spot,” or current price of the underlying commodity, that thus affects the value of the security.

More specifically, the subject invention pertains to dynamic Shipping Certificates for the subject commodity as well as the novel assessment of “roll” necessitated by gains or losses realized in the value on a monthly basis unique to the commodities market.

Because of logistical considerations involved in the physical delivery of Crude Oil, it is necessary for the Issuers of Shipping Certificates to have prior notice of an Owner's intention to take delivery. For example, in order to arrange for delivery of Crude Oil in the month of July, an Issuer of Crude Oil Shipping Certificates would require notice by a specific date in June from the Owner of such instruments. After that date, the Owner could no longer demand that delivery of Crude Oil be made in July, but could only demand delivery during the next month, in August.

The Shipping Certificates of the subject invention are based on a “roll neutrality” calculation based on both “spot month” oil (i.e. the month after the month in which notice by the Owner is given) and “second nearby” oil (i.e. the month after the spot month) over a three-day “roll period” as further described below. The roll period will begin on the ninth business day before the “Expiration Date”, on the NYMEX for example, in each calendar month. The Expiration Date is the expiration date of the current spot futures contract for Crude Oil, currently three business days before the twenty-fifth calendar day of each month. As discussed below, it is expected that, absent the “roll neutrality” adjustment of the present invention, there would be significant economic gains or losses associated with this “roll” into the succeeding delivery month as described above. Failure to make such adjustment would render the Shipping Certificates as well as the commodities-based ETF of the subject invention less useful. Note, however, that to calculate the net asset value (NAV) all “second nearby” oil is used. Similarly, during the roll period, if the Shipping Certificate is surrendered all “second nearby” oil is to be received.

In trading, for example of Crude Oil futures on the NYMEX and elsewhere, there is frequently a significant divergence between the trading price of the “spot” contract (which is the futures contract closest to Expiration Date) and more distant futures contracts. For example, in the first part of June, the July contract is the “spot” contract. If at that time the August contract is trading below the July spot contract, the condition is called “backwardation.” If the August contract is trading above the July spot contract, the condition is called “contango.” In either case, the “roll” under the Shipping Certificates can be expected to be advantageous to one of the Issuer and the Owner and disadvantageous to the other, in a similar way absent the “roll neutrality” (defined in the next paragraph below) adjustment of the present invention. Indeed, the “net asset value” of the ETF will be determined based upon the NYMEX trading price of that futures contract contemplating delivery in the same month(s) as the ETFs Shipping Certificates.

In order for the Shipping Certificates to be fair to both the Issuer and the Owner, and to ensure that the ETF Shares track changes in the spot price over the longer term, a mechanism has been invented as described herein that provides “roll neutrality,” whereby the price fluctuation in the commodities is mitigated to favor neither the Issuer nor the Owner. The subject invention accomplished this “roll neutrality” by providing for an adjustment to the number of barrels of Crude Oil deliverable under the Shipping Certificate, such adjustment to be calculated on the basis of the backwardation or contango in NYMEX trading over a three-day roll period.

### The Exchange Traded Fund (ETF)

### Overview

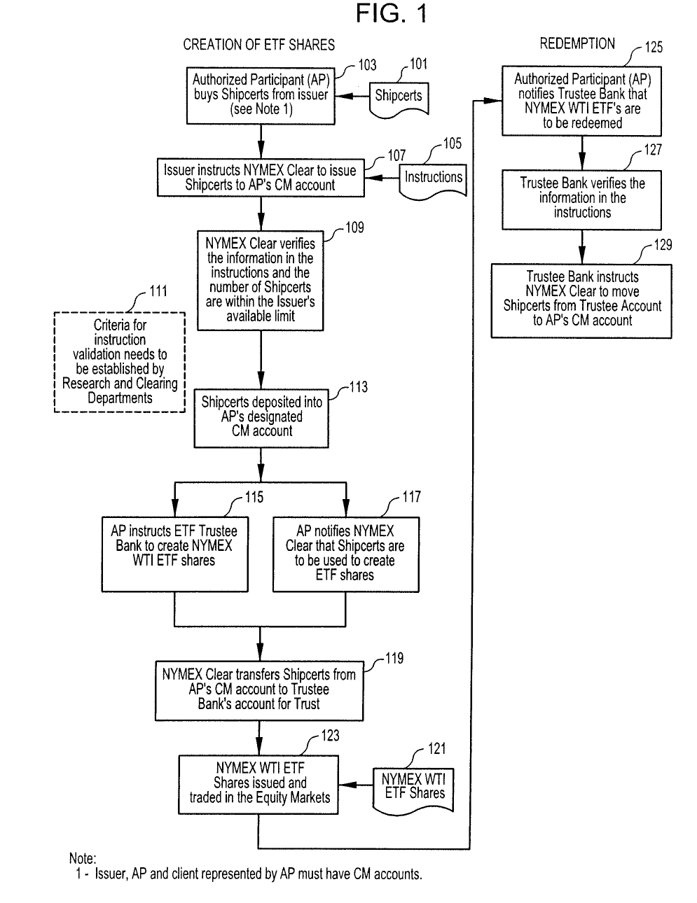

Next referring to FIG. 1, a flow chart of the functioning of the ETF of the subject invention is provided wherein ETF Shares are first created and then redeemed. At block 101, “Shipcerts,” or Shipping Certificates, described in further detail herein, are issued. At block 103 an Authorized Participant of the ETF (AP, herein) buys the Shipcerts from the Issuer of the Shipcerts. Block 105 denotes the existence of the Instructions related to the Shipcerts. Pursuant to these Instructions, at block 107 the Issuer of the Shipcerts instructs NYMEX Clear (a clearing house) to issue the purchased Shipcerts to the account of the AP. At block 109, NYMEX Clear verifies the information in the Instructions of block 105, as well as that the quantity of Shipcerts to be issued to the AP are within the available limit of the Issuer. The criteria on which the Instructions of block 109 are based have been previously promulgated at block 111. Next, the AP instructs the Distributor and the ETF that it intends to deposit Shipcerts in exchange for one or more whole Creation Units of NYMEX ETF Shares at block 115. The AP also notifies NYMEX Clear that the Shipcerts are to be used to create ETF Shares at block 117. At block 119, NYMEX Clear transfers the Shipcerts from the account of the AP in trust to the account of the ETF maintained by the custodian bank. NYMEX ETF Shares, located at block 121, are issued delivered to the AP, and thereafter are available for purchase, sale and trade in the known equity markets, at block 123.

The above described the creation of NYMEX ETF Shares. Their redemption is next described as shown in FIG. 1. At block 125 the AP notifies the ETF (and the Distributor) that it intends to redeem one or more whole Creation Units of the NYMEX ETF Shares. The ETF then notifies the custodian bank, at block 127, and verifies the redemption instructions received from the AP. At block 129, the custodian bank instructs NYMEX Clear to transfer the Shipcerts from the ETF's account residing at the custodian bank to the account of the AP. It will be understood by one skilled in the art that the Shipcerts can be transferable between owners who have the necessary accounts, e.g. at NYMEX Clear, through over-the-counter sales independent of market creations and redemptions.

### The Shipping Certificate

As stated above, an AP obtains the Shipping Certificate(s), by paying the Issuer the current market value, and then depositing the Shipping Certificate(s) with the ETF where it is held by the ETF's custodian bank (FIG. 1, block 119). The ETF's custodian bank accepts the Shipping Certificates electronically and the ETF issues the corresponding number of NYMEX ETF Shares to the AP. The AP may then fill prior order(s) for the Shares, buy Shares as agent for a large investor, purchase Shares for its own account and/or lend out Shares to short sellers.

Each business day, Shipping Certificates will be valued at the spot price for Crude Oil, except during the roll period. The roll period is defined as the period of three (3) business days during which the roll amount will be calculated, commencing on the ninth (9th) business day immediately preceding the expiration date of each calendar month and concluding on the seventh (7th) business day immediately preceding the expiration date of each such calendar month. The expiration date is defined as the expiration date of the current spot futures contracts for Crude Oil, currently the third business day prior to the twenty-fifth (25th) calendar day of each month, or if such calendar day is not a business day, the expiration date shall mean the business day immediately preceding such calendar day.

During the roll period, the Exchange will calculate the roll amount. The roll amount is defined as the amount that the owner of a Shipping Certificate is either entitled to receive from the Issuer (when the market for Crude Oil futures is in backwardation) or obligated to pay to the Issuer (when the market for Crude Oil futures is in contango). The roll amount will be published on the Exchange's Website and will be calculated during each roll period month by applying the roll formula detailed below. The roll formula will be applied by the Exchange to the difference between the settlement prices of the near month and the next month futures contracts for Crude Oil trading on the Exchange during the roll period. The roll amount will be implemented by an adjustment to the quantity of barrels of Crude Oil deliverable under the related Shipping Certificate, rather than by means of a cash payment by or to the Issuer, as roll adjustments have been previously made. The number of barrels of Crude Oil will be increased or decreased, as appropriate, immediately following receipt or payment of roll amounts and payment of ETF expenses, as such adjusted number is calculated, recorded, and displayed on the Exchange Website.

### Roll Neutrality Adjustment

It is expected that the value of the Shipping Certificates for Crude Oil described herein above will generally be determined primarily by the trading price of the “nearby” NYMEX Crude Oil futures contract (sometimes called the “spot” contract), which is the futures contract that contemplates delivery of Crude Oil within the next month.¹ The NAV of the ETF will be ¹ NYMEX futures contracts require delivery no earlier than the first calendar day of the delivery month and no later than the last calendar day of the delivery month. determined similarly, and the trading prices of the Shares are expected also to correlate to the pricing of such contracts. Since the spot contract ceases trading several business days before the beginning of the delivery month, a mechanism is needed to “roll” from the current spot contract to the next month's contract which becomes the new spot contract, twelve times a year. This is especially important because it is often the case that the trading price of the next month's contract is significantly more or less than the trading price of the expiring spot contract.

Commodity markets are unique among financial markets in that there are gains or losses realized in the change in value from one contract month (or set of contract months) to another contract month (or set of contract months). This change in value can be realized when one closes out a position in the current spot month and “rolls that position” and takes an equivalent position in the next month. For example, one has a long position in the May Crude Oil contract and when May is the spot month for Crude Oil, one sells the May contracts and buys an equal number of June Crude Oil contracts. There may be gains or losses in this transaction which result from the interaction of carrying charges and supply/demand conditions for the underlying commodities. We have invented methods to be applied to commodity-based securities to enable those securities to accurately reflect these gains and losses.

If the next month contract is trading below the current spot contract, the condition is called “backwardation.” If the next month contract is above the current spot, this is “contango.” In either case, in order for the Shipping Certificates to be fair to both parties, and to ensure that the Shares track changes in the spot price over the longer term, a roll mechanism must be devised to provide “roll neutrality.”

In contrast to the “roll” adjustment of traditional futures contracts whereby a futures contract of a longer time frame is purchased to maintain a particular commodity futures position, the “roll neutrality” adjustment associated with the subject invention relates not to the cost of the actual purchase of a more distant futures contract, but instead is designed to neutralize or ameliorate the effects of possible dramatic monthly changes in the price of commodities on both the issuer and the Shareholders of a commodities-based ETF, tied to the “spot,” or current, price of such underlying commodities, that therefore affects the value of this related ETF. The following are possible roll neutrality structures.

In “Naïve roll,” at the time of roll, the value of the ETF's Assets shifts from current spot month value to succeeding spot month value. No monies related to roll are collected from the Asset issuer or paid out by ETF.

In “Roll-neutral ex post roll,” the value of the ETF's Assets stays same at time of roll (roll yield is calculated after actual roll). In event the spot month is more valuable than or equal to next month at time of roll, the difference will be paid by the Asset issuer to the ETF, which assigns this difference to Shareholders of the ETF as dividends. Thus, the value of the ETF stays same, though its Share price will likely drop by the value of the dividend at time of payment. (Equal values imply a dividend equal to zero). In the event the spot month is less valuable than succeeding month at time of roll, the difference will be paid by the owner of the Assets (in this case the ETF) to the Asset issuer as storage costs. These costs will be paid by the ETF out of the proceeds it receives from sales of the Assets held in its portfolio. To extent any unpaid dividends accrue over the same period, they will be used as an offset. The value of the ETF's Assets will remain the same, though its Share price will likely rise by the amount of the storage cost. This method, and roll neutral ex ante roll (below), can be varied to have payment and accruals over different schedules than indicated above (daily, monthly, quarterly and annually).

In Roll-neutral ex ante roll, the expected value of ETF stays same at time of roll (roll yield is calculated prior to actual roll). The Asset issuer will incorporate expected storage costs due to contango into the up-front costs of issuing the Asset as fee to be paid during the year. To do this, the Asset issuer must take on the risk of a contango market and therefore must assess the ETF accordingly. In the event the spot month is more valuable than or equal to next month at time of roll, the difference will be assigned to Shareholders of the ETF as dividends. Thus, value of the ETF stays same, though the price of its Shares will likely drop by value of the dividends at time of payment. (Equal values imply a dividend equal to zero.) In event the spot month is less valuable than succeeding month at the time of roll, then the value of the ETF shifts from the spot month value to the succeeding month value. There would, presumably, be a shift in price associated with the contango yield though it is not obvious when it would “hit” the ETF share price. As indicated above, the Asset issuer would assume the risk associated with change in value due to contango and, presumably, covered it in costs ahead of time. In fact, the Asset issuer will look to the prices in the corresponding commodity futures market to determine the cost to eliminate this risk. Note that eliminating the risk altogether would be relatively expensive as opposed to managing the risk based upon assessing the likelihood of a market shifting to contango. Presumably, if the near-term months are in contango to begin with, the price of the ETF's Shares would reflect that.

For the Shipping Certificates of each type of commodity (e.g. Crude Oil, natural gas, and coal), a specific rule will be specified from the various approaches to calculating the roll differential. The roll from spot contract to the succeeding contract month can be calculated by: the difference in final settlement prices for Crude Oil futures contracts between the spot month and the next contract month (becoming spot next trading day) on the close of the last day of the spot contract, or the difference in final settlement prices for Crude Oil futures contracts between the spot month and the next contract month (becoming spot next trading day) over a specified single or multiple-day period earlier in the spot contract, or also, the prices used can be varied, i.e. rather than the final settlement price an average (arithmetic or weighted by trading volume) of prices during specified periods could be used, or the opening range of prices on specified days.

Cash can move in and out of the ETF in a number of ways. Assets may be sold to pay fixed expenses. Assets may also be sold when roll yield is negative for the investor. The ETF may gain revenue by dividend payments from the Asset issued to the trust when roll yield is positive for the investor. The trust may pay out dividends to the investors when the dividends paid to the trust are greater than the sum of fixed expenses and asset sale to cover negative roll yield over a period of time.

There will always only be one NYMEX settlement price used to calculate the value of the ETF's Assets. The settlement price will either be the settlement price for the spot (first nearby in NYMEX terminology) or the two months, spot and the month following spot (second nearby), contracts for the relevant commodities.

For the purpose of the below roll neutrality field calculations, “front month,” “spot month” and “first nearby” are equivalent. Roll neutrality means maintaining the value of the ETF over the period during which the spot month expires and the next month becomes spot. If the price of the ETF's Assets merely jumps from one month price to the next, this method will likely provide a shocking change to the ETF's value due to the nature of Crude Oil futures pricing. Instead, the ETF of the subject invention will have a graduated roll over a three day period to provide the fairest smoothing of roll impact to the investor, as well as to issuer of the Asset.

The roll neutrality adjustment of the subject invention will involve adjusting the quantity of barrels of Crude Oil covered by the Shipping Certificates held by the ETF to reflect the different prices for the spot and second months. This roll will be affected by rolling one third of the ETF's barrels covered by the Shipping Certificates from one month to the next on each day of the roll. The number of barrels of Crude Oil to be rolled will be the number of barrels covered by the Shipping Certificates in the ETF on the last trading day before the roll which has not changed since completion of the previous month, i.e. it stays the same from roll except for expenses. Thus, the total number of barrels of Crude Oil covered by the Shipping Certificates for the spot month will be divided by three and rolled each day during the roll period to convert the price of such barrels into the price of the next month contract.

During each day of the roll, those ⅓ of barrels of the expiring spot month are valued at that day's settlement price for the current spot month to provide a total value. This total value is divided by the settlement price on the same day for the upcoming spot month day. The quotient (or ratio) from this division provides how many second month barrels of Crude Oil to which the first months rolled barrels of Crude Oil are equivalent.

If the market is in “backwardation,” the second month price is lower than the spot month price and therefore the number of barrels covered by the Shipping Certificates held by the ETF will increase. If the market is in “contango,” the number of barrels covered by the Shipping Certificates will decline. Therefore, each day during the roll period, the total number of barrels covered by the Shipping Certificates in the ETF will increase or decrease.

### Example Roll Neutrality Adjustment

Assume that the ETF contains Crude Oil Shipping Certificates covering 900,000 July '05 barrels. On the last day prior to the roll, Jun. 9, 2005, the July '05 settlement price was $54.28 and thus the total value of the ETF's barrels of Crude Oil equaled $48,852,000. The total number of barrels in the ETF prior to the roll will be divided into thirds. With 900,000 barrels in the ETF prior to the roll, then each day of the roll 300,000 barrels of the front month will be rolled. Rolling thus encompasses: for each day of the roll, the dollar value of the 300,000 barrels will be calculated based on that day's settlement price for the front month. Assume that the front month is July '05, and the first roll date was Jun. 10, 2005. The final settlement price for July '05 was $53.54. Multiply the number of barrels being rolled (300,000) by this settlement price to obtain the total value being rolled that day, $16,062,000. Next, the amount of second nearby barrels that value will purchase is calculated by dividing that value by the settlement price for the second nearby on the same day, e.g. the August '05 price on Jun. 10, 2005 was 54.68: $16,062,00/$54.68 per barrel=293,745 August barrels. In other words, since the Crude Oil market was in contango (the farther month price higher than the nearby month) that day the ETF lost 6,254.57 barrels. The same process is repeated for the next two days of the roll period until one has completely rolled from July into August, (from the front into the second “nearby”).

The actual calculations for the next two days follow:

Roll Day 2, Jun. 13, 2005: 300,000 July '05 Barrels at $55.62=$16,686,000 which at $56.82 per August '05 barrel=293,664.20 August barrels. (The ETF has lost another 6,335.80 barrels).

Roll Day 3, Jun. 14, 2005: 300,000 July '05 Barrels at $55.00=$16,500,000 which at $55.97 per August '05 barrel=294,800.79 August barrels. (The ETF has lost another 5,199.21 barrels).

At the end of the third roll day, the ETF's Assets have been fully converted from July '05 barrels to August '05 barrels. The ETF's 882,210.42 barrels are all now valued at the August '05 price of $55.97 or is worth $49,377,317.

The effect of compensating for the change in value of the ETF from rolling a commodity can be expressed either as a change in the price of one's position or as a change in quantity of one's position. The calculation remains the same. It is a matter of how one translates the calculation to effect the result. If the quantity remains fixed, then the roll will be translated entirely as a price change and can be effected by a flow of funds from the party losing value due to the roll to the party gaining value due to the roll. For example, in a “backwardated market” for Crude Oil, the funds will flow from a issuer to a holder. In “contango,” the funds with flow from the holder to the issuer.

Conversely, if quantity is used to express the effect of roll, in “backwardation” the buyer will receive more barrels of Crude Oil from the seller, and in “contango,” the seller will provide fewer barrels of Crude Oil to the buyer. The above is summarized in Table 1, below.

TABLE 1

| | Backwardation | Contango |
|---|---|---|
| Holder | Receives $ or owns additional | Loses $ or owns fewer barrels |
| | barrels | |
| Issuer | Gives $ or provides additional | Receives $ or provides fewer |
| | barrels | barrels |

During the roll period, the ETF roll neutrality calculation is calculated based on the number of spot month barrels of Crude Oil covered by the Shipping Certificates held by the ETF, and the number of the second month barrels of Crude Oil covered by the Shipping Certificates held by the ETF. On the first day of the roll, ⅔ of the ETF's barrels from the day prior to the initial roll will be valued at the spot month price, and the remaining barrels will be valued at the second month price. On the second day of the roll, ⅓ of the ETF's barrels from the day prior to the initial roll will be valued at the spot month price, and the remaining barrels will be valued at the second month price. On the third day, as all of the barrels have been rolled into the second month they will be all valued at the second month's price. Also during the roll period, the net asset value (NAV) of the ETF is calculated based entirely on the “second nearby” oil contract (“second nearby” defined as the month after the spot month).

In other words, in order to roll futures contracts, the ETF must have an algorithm that relates the price and quantity in one month to price and quantity in the subsequent month. The algorithm must recognize the difference in price of the first two months. For example, if the price of the first month is 105% of the second nearby month, it will roll into 0.35 (1.05*0.333) barrels of the second month for that day of the three day roll. The same calculation is then made for the following two days of the roll. Prior to the roll, 100% of the ETF's barrels are priced on the front month while after the 3 day roll, 100% is priced on the second nearby contract.

The ETF's value calculation is thus: Σ Pᵢ Bᵢ,

Where Pᵢ is the price of the relevant contract month, Bᵢ is the number of barrel units for that month, and ᵢ is the time index.

The ETF's value becomes the weighted average of the price(s) times the number of unit barrels of the respective contract months, as shown in Table 2, below.

TABLE 2

| | | | Quantity of Barrels in the Trust |
|---|---|---|---|
| | Price of 1st | Price of 2nd | Pij i = day; j = contract month |
| | Nearby | Nearby | (changes each day are indicated |
| Roll Day | Contract | Contract | in bold) |
| Last Day | P₀₁ | | Q_{A} |
| Before | | | |
| Roll | | | |
| R1 | P₁₁ | P₁₂ | ⅔ Q_{A} + (P₁₁/P₁₂) ⅓ Q_{A} |
| R2 | P₁₂ | P₂₂ | ⅓ Q_{A} + (P₁₁/P₁₂) ⅓ Q_{A} + |
| | | | (P₂₁/P₂₂) ⅓ Q_{A} |
| R3 | P₃₁ | P₃₂ | 0 Q_{A} + (P₁₁/P₁₂) ⅓ Q_{A} + |
| | | | (P₂₁/P₂₂) ⅓ Q_{A} + (P₃₁/P₃₂) |
| | | | ⅓ Q_{A} |

Where:

Q_{A} is total quantity of barrels of oil in the trust on the last day before the roll

P=price

i=day

j=contract month

if j=1; “spot”

if j=2; “second nearby”

To understand the roll's effect on the number of barrels in the trust, consider it as if one is “selling” a certain percentage of the total number of barrels at the spot month price and taking the proceeds from that “sale” and buying as many barrels at the second nearby price as one can. It is important to understand that there is no actual “sale” or “purchase” of barrels. The total number of barrels is being readjusted according to the relative prices of the spot and second nearby. The number of barrels per shipping certificate is calculated by dividing the total number of barrels in the trust by the number of outstanding shipping certificate.

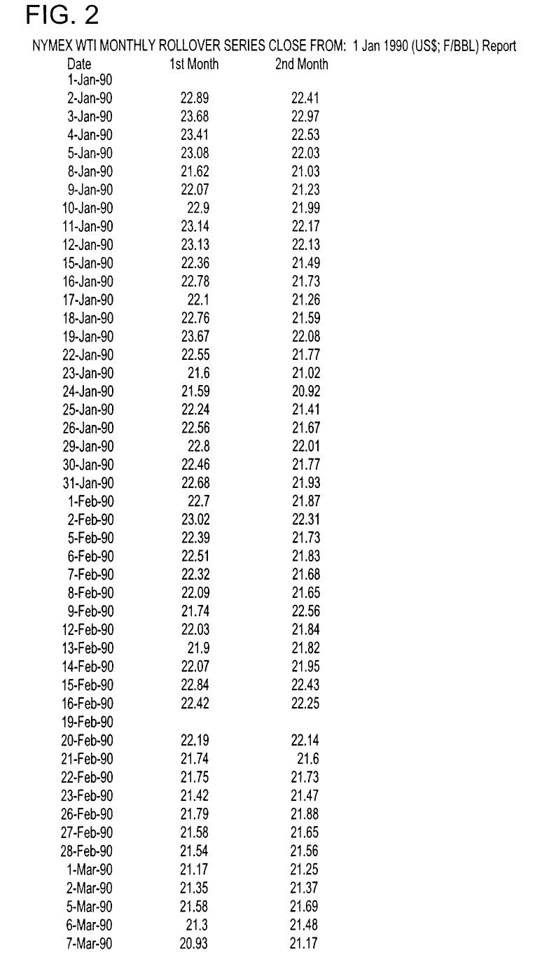

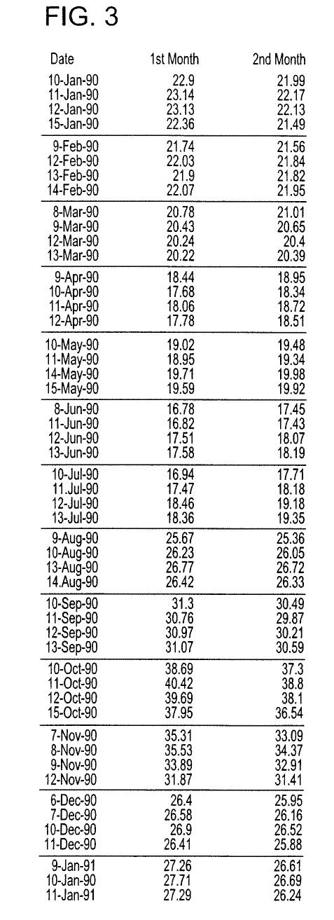

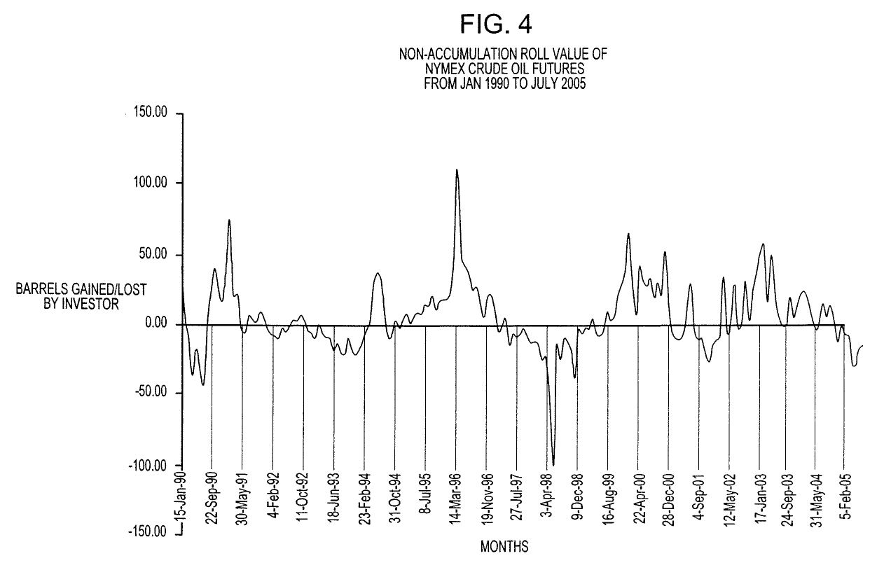

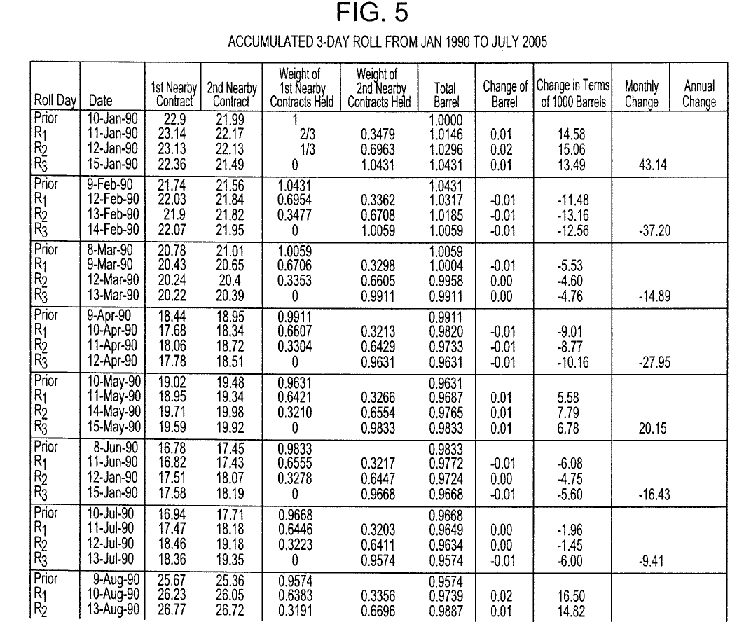

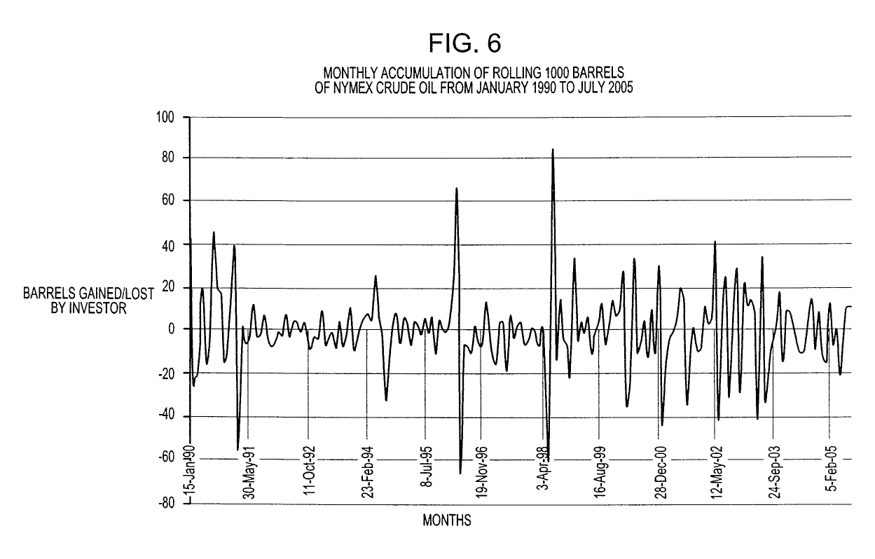

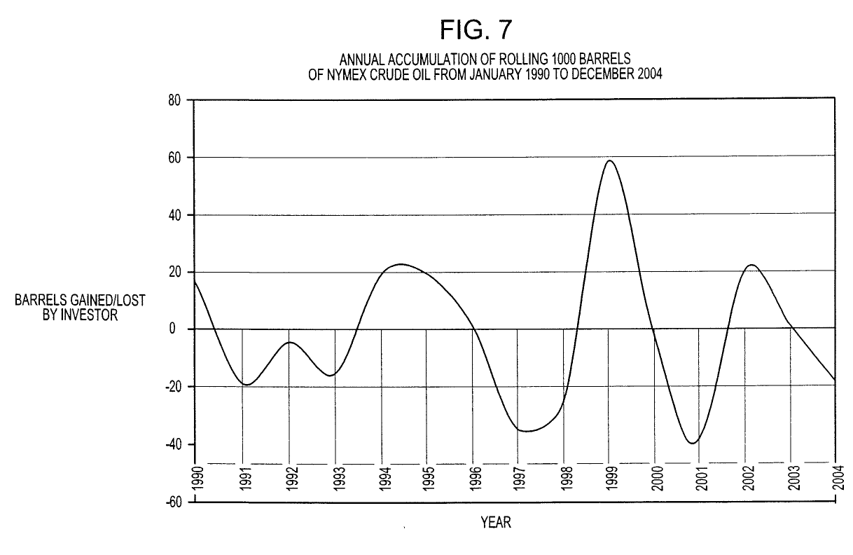

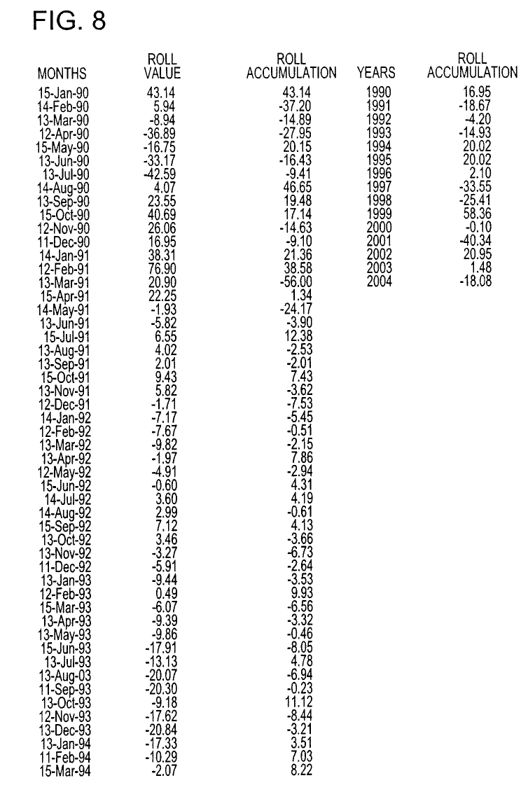

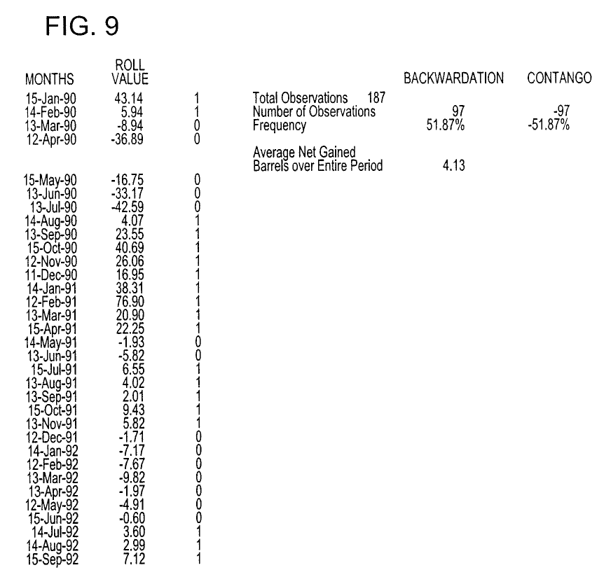

Next referring to FIGS. 2-9, data for roll activity as calculated by the subject invention is provided. First referring to FIG. 2, 1^{st} month and 2^{nd} month price data on a daily basis is provided. FIG. 3 shows a portion of the price data of FIG. 2, namely price data for selected roll dates only. FIG. 4 is a chart showing the barrels gained or lost from January 1990 to July 1995 for Crude Oil futures employing the roll adjustment method of the subject invention. FIG. 4 shows data on a “non-accumulation” basis, meaning that the starting position each month is re-set to 1,000 barrels. FIG. 5 is a chart providing “accumulated” 3-day roll data based on the roll adjustment method of the subject invention. “Accumulated” means that the barrel amount is carried over from a month to the subsequent month, and is not re-set to a predetermined barrel value as in “non-accumulated” data analysis. The “3-day roll” refers to the number of rolls for each period, designated as R₁, R₂, and R₃ in FIG. 5. FIG. 5 also shows the Change of Barrel, which reflects the increase or decrease in barrels held, as also shown on a monthly (monthly change) basis. FIG. 6 shows the data of FIG. 5, plotted monthly from January 1990 to July 2005 in a chart denoting barrels gained or lost. FIG. 7 is a chart similar to FIG. 6, but on an annual, not monthly basis. FIG. 8 shows roll data based on the roll adjustment method of the subject invention on a monthly basis as both Roll Value and Roll Accumulation, and also shows Roll Accumulation on a yearly basis. FIG. 9 shows the frequency of Backwardation versus Contango for the data of FIGS. 2 through 8.

Although the invention has been shown and described with respect to a best mode embodiment thereof, it should be understood by those skilled in the art that various changes, omissions, and additions may be made to the form and detail of the disclosed embodiment without departing from the spirit and scope of the invention, as recited in the following claims.

We claim:

1. A commodities-based security wherein said security has a value, said value periodically reassessed resulting in a change in the amount of said commodities held by said security.

2. The security of claim 1 wherein said security has an associated shipping certificate, said shipping certificate having a commodities certificate amount, said shipping certificate commodities certificate amount being a function of roll of said commodities.

3. The security of claim 1 wherein said security has an associated shipping certificate, said shipping certificate having a stated initial commodities certificate amount, said shipping certificate stated initial commodities certificate amount being adjustable thereafter based on roll of said commodities.

4. The security of claim 1 wherein said reassessment of said security value is to maintain roll neutrality of said commodities.

5. The security of claim 1 wherein said value of said security is based on the futures contract for said commodities.

6. The security of claim 5 wherein said reassessment of said security value is based on the weighted average of prices of said commodities in a predetermined number of futures contract months multiplied by the number of units of said commodities in said predetermined number of futures contract months.

7. The security of claim 1 wherein said reassessment of said security value is based on the formula:
ΣPᵢBᵢ,
Where Pᵢ is the price of the relevant contract month, Bᵢ is the number of commodity units for that month, and ᵢ is the time index.

8. The security of claim 1 wherein said reassessment of said security value is based on the weighted average of prices of said commodities in a predetermined number of time periods multiplied by the number of units of said commodities in said predetermined number of time periods.

9. The security of claim 1 wherein the price of said commodities is maintained constant as said amount of said commodities is changed.

10. The security of claim 1 wherein said security is an exchange traded fund.

11. A commodities based security wherein said security has a value, said value periodically reassessed resulting in a change in the amount of said commodities held by said security, said reassessment of said security value is to maintain roll neutrality of said commodities, and said value of said security is based on the futures contract for said commodities.

12. The security of claim 11 wherein said security has an associated shipping certificate, said shipping certificate having a commodities certificate amount, said shipping certificate commodities certificate amount being a function of roll of said commodities.

13. The security of claim 11 wherein said security has an associated shipping certificate, said shipping certificate having an initial stated commodities certificate amount, said shipping certificate initial stated commodities certificate amount being adjustable thereafter based on roll of said commodities.

14. The security of claim 11 wherein said reassessment of said security value is based on the weighted average of prices of said commodities in a predetermined number of futures contract months multiplied by the number of units of said commodities in said predetermined number of futures contract months.

15. The security of claim 11 wherein said reassessment of said security value is based on the formula:
ΣPᵢBᵢ,
Where Pᵢ is the price of the relevant contract month, Bᵢ is the number of commodity units for that month, and ᵢ is the time index.

16. The security of claim 11 wherein the price of said commodities is maintained constant as said amount of said commodities is changed.

17. The security of claim 11 wherein said security is an exchange traded fund.

18. A commodities based security wherein said security has a value, said value periodically reassessed resulting in a change in the amount of said commodities in said security and said reassessment of said security value is to maintain roll neutrality of said commodities.

19. The security of claim 18 wherein said security has an associated shipping certificate, said shipping certificate having a commodities certificate amount, said shipping certificate commodities certificate amount being a function of roll of said commodities.

20. The security of claim 18 wherein said security has an associated shipping certificate, said shipping certificate having an stated initial commodities certificate amount, said shipping certificate stated initial commodities certificate amount being adjustable thereafter based on roll of said commodities.

21. The security of claim 18 wherein said value of said security is based on the futures contract for said commodities.

22. The security of claim 21 wherein said reassessment of said security value is based on the weighted average of prices of said commodities in a predetermined number of futures contract months multiplied by the number of units of said commodities in said predetermined number of futures contract months.

23. The security of claim 18 wherein said reassessment of said security value is based on the formula:
ΣPᵢBᵢ,
Where Pᵢ is the price of the relevant contract month, Bᵢ is the number of commodity units for that month, and ᵢ is the time index.

24. The security of claim 18 wherein the price of said commodities is maintained constant as said amount of said commodities is changed.

25. The security of claim 18 wherein said reassessment of said security value is based on the weighted average of prices of said commodities in a predetermined number of time periods multiplied by the number of units of said commodities in said predetermined number of time periods.

26. The security of claim 18 wherein said security is an exchange traded fund.

27. A method of managing a commodities-based security wherein said security has a value, comprising:
periodically reassessing said value resulting in a change in the amount of said commodities in said security.

28. The method of claim 27 wherein said security has an associated shipping certificate, said shipping certificate having a commodities certificate amount, said shipping certificate commodities certificate amount being a function of roll of said commodities.

29. The method of claim 27 wherein said security has an associated shipping certificate, said shipping certificate having an stated initial commodities certificate amount, said shipping certificate stated initial commodities certificate amount being adjustable thereafter based on roll of said commodities.

30. The method of claim 27 wherein said reassessment of said security value is to maintain roll neutrality of said commodities.

31. The method of claim 27 wherein said value of said security is based on the futures contract for said commodities.

32. The method of claim 31 wherein said reassessing of said security value is based on the weighted average of prices of said commodities in a predetermined number of futures contract months multiplied by the number of units of said commodities in said predetermined number of futures contract months.

33. The method of claim 27 wherein said reassessing of said security value is based on the formula:
ΣPᵢBᵢ,
Where Pᵢ is the price of the relevant contract month, Bᵢ is the number of commodity units for that month, and ᵢ is the time index.

34. The method of claim 27 wherein said reassessing of said security value is based on the weighted average of prices of said commodities in a predetermined number of time periods multiplied by the number of units of said commodities in said predetermined number of time periods.

35. The method of claim 27 wherein the price of said commodities is maintained constant as said amount of said commodities is changed.

36. The method of claim 27 wherein said security is an exchange traded fund.

37. A method of managing a commodities based security wherein said security has a value, comprising:
periodically reassessing said value resulting in a change in the amount of said commodities in said security, said reassessment of said security value to maintain roll neutrality of said commodities, and said value of said security based on the spot futures contract for said commodities.

38. The method of claim 37 wherein said security has an associated shipping certificate, said shipping certificate having a commodities certificate amount, said shipping certificate commodities certificate amount being a function of roll of said commodities.

39. The method of claim 37 wherein said security has an associated shipping certificate, said shipping certificate having a stated initial commodities certificate amount, said shipping certificate stated initial commodities certificate amount being adjustable thereafter based on roll of said commodities.

40. The method of claim 37 wherein said reassessment of said security value is based on the weighted average of prices of said commodities in a predetermined number of futures contract months multiplied by the number of units of said commodities in said predetermined number of futures contract months.

41. The method of claim 37 wherein said reassessment of said security value is based on the formula:
ΣPᵢBᵢ,
Where Pᵢ is the price of the relevant contract month, Bᵢ is the number of commodity units for that month, and ᵢ is the time index.

42. The method of claim 37 wherein the price of said commodities is maintained constant as said amount of said commodities is changed.

43. The method of claim 37 wherein said security is an exchange traded fund.

44. A method of managing a commodities based security wherein said security has a value, comprising:
periodically reassessing said value resulting in a change in the amount of said commodities in said security and said reassessment of said security value is to maintain roll neutrality of said commodities.

45. The method of claim 44 wherein said security has an associated shipping certificate, said shipping certificate having a commodities certificate amount, said shipping certificate commodities certificate amount being a function of roll of said commodities.

46. The method of claim 44 wherein said security has an associated shipping certificate, said shipping certificate having a stated initial commodities certificate amount, said shipping certificate stated initial commodities certificate amount being adjustable thereafter based on roll of said commodities.

47. The method of claim 44 wherein said value of said security is based on the futures contract for said commodities.

48. The method of claim 47 wherein said reassessing of said security value is based on the weighted average of prices of said commodities in a predetermined number of futures contract months multiplied by the number of units of said commodities in said predetermined number of futures contract months.

49. The method of claim 44 wherein said reassessing of said security value is based on the formula:
ΣPᵢBᵢ,
Where Pᵢ is the price of the relevant contract month, Bᵢ is the number of commodity units for that month, and ᵢ is the time index.

50. The method of claim 44 wherein the price of said commodities is maintained constant as said amount of said commodities is changed.

51. The method of claim 44 wherein said reassessing of said security value is based on the weighted average of prices of said commodities in a predetermined number of time periods multiplied by the number of units of said commodities in said predetermined number of time periods.

52. The method of claim 44 wherein said security is an exchange traded fund.

53. A commodities-based security wherein said security has a value, said value periodically reassessed wherein said security has an associated shipping certificate, said shipping certificate having a commodities certificate amount, said shipping certificate commodities certificate amount being adjustable to maintain roll neutrality of said commodities.

54. The security of claim 53 wherein said value of said security is based on the futures contract for said commodities.

55. The security of claim 54 wherein said reassessment of said security value is based on the weighted average of prices of said commodities in a predetermined number of futures contract months multiplied by the number of units of said commodities in said predetermined number of futures contract months.

56. The security of claim 53 wherein said reassessment of said security value is based on the formula:
ΣPᵢBᵢ,
Where Pᵢ is the price of the relevant contract month, Bᵢ is the number of commodity units for that month, and ᵢ is the time index.

57. The security of claim 53 wherein said reassessment of said security value is based on the weighted average of prices of said commodities in a predetermined number of time periods multiplied by the number of units of said commodities in said predetermined number of time periods.

58. The security of claim 53 wherein said security is an exchange traded fund.

59. A method of managing a commodities based security wherein said security has a value, comprising:
periodically reassessing said value wherein said security has an associated shipping certificate, said shipping certificate having a commodities certificate amount, said shipping certificate commodities certificate amount being adjustable to maintain roll neutrality of said commodities.

60. The method of claim 59 wherein said value of said security is based on the futures contract for said commodities.

61. The method of claim 60 wherein said reassessing of said security value is based on the weighted average of prices of said commodities in a predetermined number of futures contract months multiplied by the number of units of said commodities in said predetermined number of futures contract months.

62. The method of claim 59 wherein said reassessing of said security value is based on the formula:
ΣPᵢBᵢ,
Where Pᵢ is the price of the relevant contract month, Bᵢ is the number of commodity units for that month, and ᵢ is the time index.

63. The method of claim 59 wherein said reassessing of said security value is based on the weighted average of prices of said commodities in a predetermined number of time periods multiplied by the number of units of said commodities in said predetermined number of time periods.

64. The method of claim 59 wherein the price of said commodities is maintained constant as said amount of said commodities is changed.
